(19) United States
(12) Patent Application Publication
(10) Pub. No.: US 2003/0143974 A1
(43) Pub. Date: Jul. 31, 2003

(54) Emergency warning indication over a wireless network

(76) Inventor: Randy Navarro, Carlsbad, CA (US)

Correspondence Address: HARNESS, DICKEY & PIERCE, P.L.C., P.O. BOX 828, BLOOMFIELD HILLS, MI, 48303, US

(21) Appl. No.: 10/062,642

(22) Filed: Jan. 30, 2002

(51) Int. Cl. H04M 11/00

(52) U.S. Cl. 455/404; 455/466

(57) ABSTRACT

An emergency message may be generated and transmitted to all mobile stations in an affected area. The emergency message may warn of imminent danger, such as hazardous weather reports generated by the National Weather Service. The emergency message is received by a wireless communication system that determines the geographic region affected by the message. The wireless communication system then transmits the message to all mobile stations within the affected region. The mobile stations alert the user to the emergency message and displays the message to the user.

### TECHNICAL FIELD

This invention relates to emergency warnings, and more particularly to providing emergency warnings over a wireless network.

### BACKGROUND

A recent development in mobile cellular systems is the ability to transfer short messages between an application residing on a mobile station and another application residing on a mobile network element, such as a message center for example. This service is sometimes referred to as a SMS (short message service). These messages might include mobile originated point-to-point messages, mobile terminated point-to-point, and broadcast for example.

Weather information is often sourced from a national weather service, particularly when emergency conditions exist. For example, the National Oceanic and Atmospheric Administration (NOAA) of the United States of America operates the National Weather Service (NWS), which broadcasts information, derived from data collected at various observing stations, for public dissemination. The NWS provides detailed location specific information which may be invaluable for certain users. Such information is currently disseminated through radio broadcasts and other bulk distribution methods.

Although the current weather reporting and forecasting systems used by television stations and networks have much benefit, they may not provide relevant weather information during severe weather. This is particularly true when it comes to the existence of severe weather which arises quickly without much warning, as is often the case with tornados. The information provided by the television stations and networks regarding these types of severe weather are seldom provided in a real-time fashion and are generally not detailed as to the specific location or direction of the weather front. Therefore, the public is often not given sufficient warning to adequately prepare for the weather in order to protect their property or find a safe refuge for themselves. Moreover, the weather information that is provided is often provided on a large scale basis which, depending on the size of the area, the actual path of the severe weather, and the position of the people within the area, may be irrelevant. What is needed is a system of informing people about severe weather specifically for the area they are in or around.

### SUMMARY

An emergency message may be generated and transmitted to all mobile stations in an affected area. The emergency message may warn of imminent danger, such as hazardous weather reports generated by the National Weather Service. The emergency message is received by a wireless communication system that determines the geographic region affected by the message. The wireless communication system then transmits the message to all mobile stations within the affected region. The mobile stations alert the user to the emergency message and displays the message to the user.

### DESCRIPTION OF DRAWINGS

These and other features and advantages of the invention will become more apparent upon reading the following detailed description and upon reference to the accompanying drawings.

FIG. 1 illustrates components of a wireless communication system appropriate for use with an embodiment of the invention.

FIG. 2 is a block diagram showing features of a mobile station according to one embodiment of the invention.

FIG. 3 is a flowchart showing the process used by the wireless communication system to distribute the emergency messages according to one embodiment of the invention.

FIG. 4 is a flowchart showing the process used by the mobile station upon receipt of the emergency message according to one embodiment of the invention.

### DETAILED DESCRIPTION

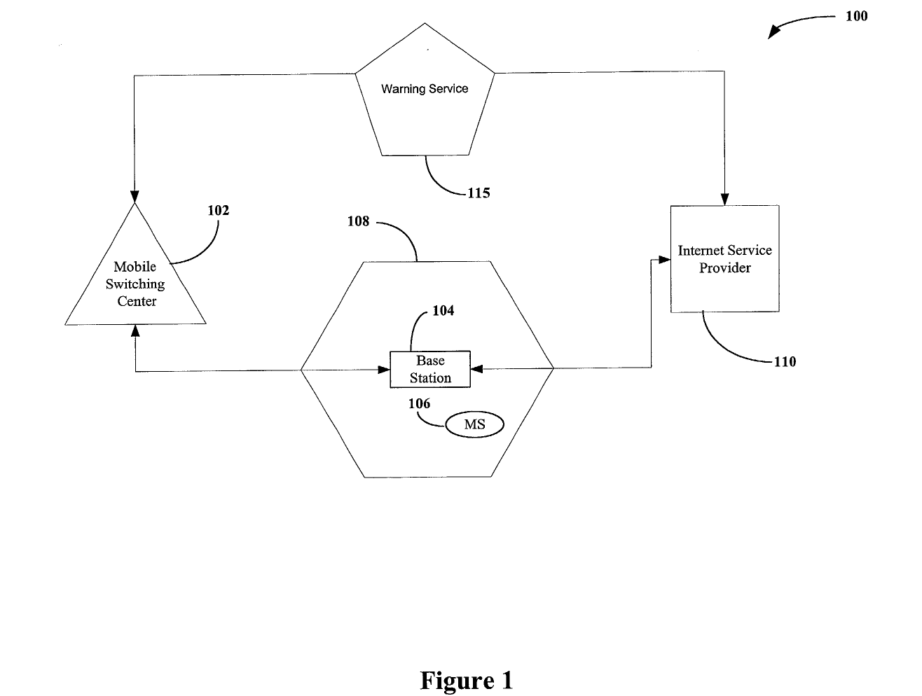

FIG. 1 illustrates components of a wireless communication system 100. A mobile switching center 102 communicates with a base station 104. The base station 104 broadcasts data to and receives data from mobile stations 106 within a cell 108. The cell 108 is a geographic region, roughly hexagonal, having a radius of up to 35 kilometers or possibly more. The base station 104 may also communicate with an Internet Service Provider (ISP) 110. The ISP 110 provides an interface between the wireless communication system 100 and the world wide web, or Internet. In some embodiments, the mobile station 106 communicates with the ISP 110 through the base station 104. However, it can be appreciated that the mobile station 106 may directly communicate with the ISP 110.

A warning service 115, such as the National Weather Service, may also communicate with the wireless communication system 100. The warning service 115 may communicate with the ISP 110, or the mobile switching center 105. The warning service 115 may broadcast emergency messages concerning a variety of matters, such as hazardous weather conditions.

The mobile station 106 is capable of receiving data from and transmitting data to a base station 104. Additional cells adjacent to the cell 108 permit mobile stations 106 to cross cell boundaries without interrupting communications. This is because base stations 104 in adjacent cells assume the task of transmitting and receiving data for the mobile stations 106. The mobile switching center 102 coordinates all communication to and from mobile stations 106 in a multi-cell region, thus the mobile switching center 102 may communicate with many base stations 104.

The mobile stations 106 may move about freely within the cell 108 while communicating either voice or data. The mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone synchronizes communication with the base station 104. The cellular telephone then registers with the mobile switching center 102 to make itself known as an active user within the wireless network.

The mobile station 106 scans data frames broadcast by the base station 104 to detect any telephone calls or paging messages directed to the cellular telephone. In this call detection mode, the mobile station 106 receives, stores and examines paging message data, and determines whether the data contains an identifier matching an identifier of the mobile station 106. If a match is detected, the mobile station 106 establishes a call with the mobile switching center 102 via the base station 104. If no match is detected, the mobile station 106 enters an idle state for a predetermined period of time, then exits the idle state to receive another transmission of paging message data.

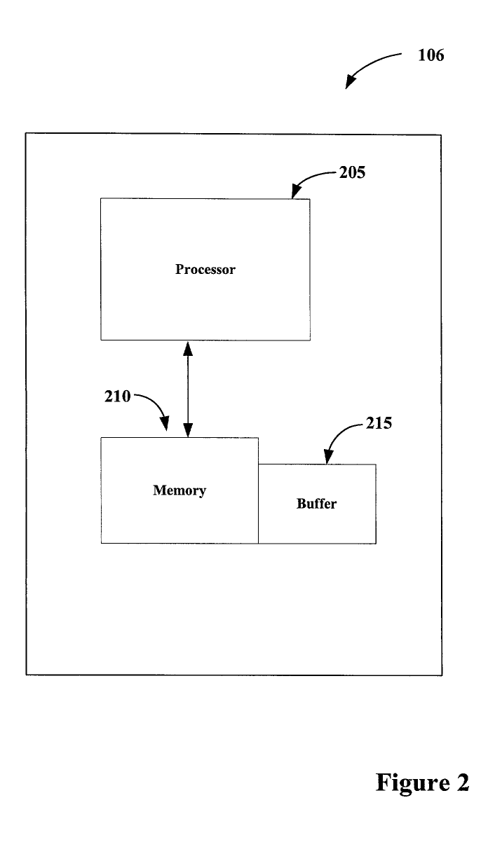

FIG. 2 shows a block diagram of the mobile station 106 and the processing that occurs in that mobile station 106. A processor 205 is driven by programs stored in a memory 210. Any information received by the mobile station 106 may be stored in the memory 210 or a buffer 215. The buffer 215 may store information obtained from the Internet service provider 110.

One technique used by the mobile station 106 to interface with the Internet is the Wireless Application Protocol (WAP). WAP sends multiple WEB pages, for example, in a single transmission as a “deck” of “cards,” each card corresponding to a page of structured content and navigation specifications. The use of WAP along with SMS provides one technique for communication of short messages to the mobile station.

The wireless communication system 100 of the present invention may broadcast emergency information such as that provided by the NWS to the mobile stations 106. The emergency information may be transmitted to select mobile stations 106 depending on a variety of factors, including geographic position. For example, the wireless communication system 100 may broadcast an emergency message concerning hazardous weather conditions in a limited area. The wireless communication system 100 communicates the message to any base stations 104 that cover any portion of the affected area. The base stations 104 may then transmit the message to the mobile stations 106 in the affected area. The base stations 104 may either transmit the emergency message to all the mobile stations 106 communicating with the base station 104 or determine the position of each mobile station 106 and only transmit the message to those identified to be in a danger area. Determination of the position of a mobile station 106 may be accomplished in a variety of manners known in the art, such as global positioning, triangulation, etc. and will not be discussed herein.

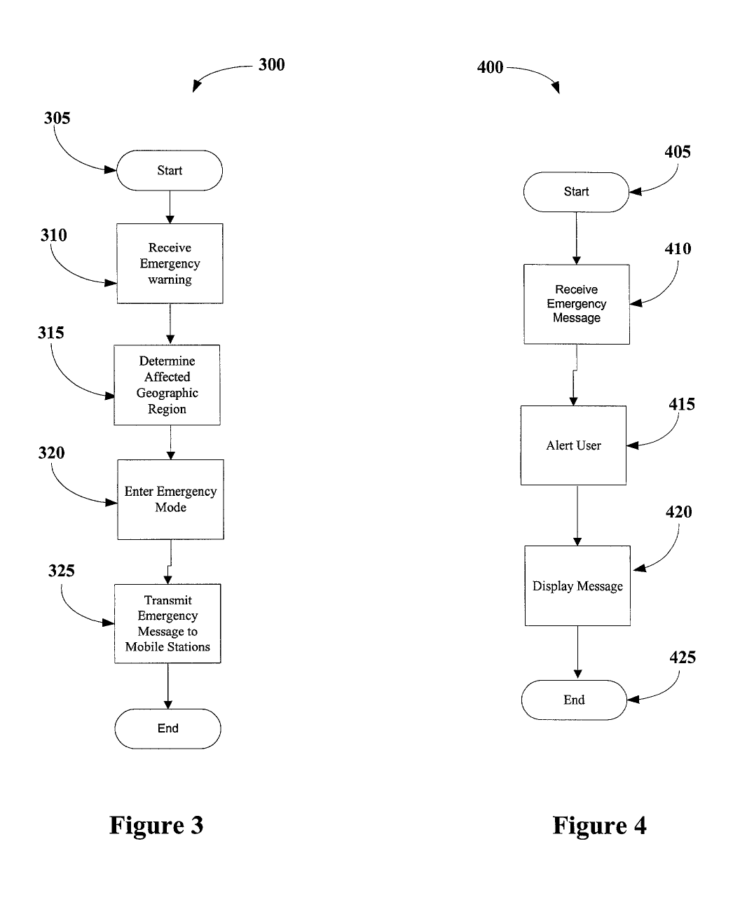

FIG. 3 is a flowchart showing the process 300 the wireless communication system 100 uses to distribute the emergency messages. The process 300 begins in a START block 305. Proceeding to block 310, the wireless communication system 100 receives an emergency warning message. The emergency warning message may be received from a service such as the National Weather Service or the local law enforcement. The message may include security provisions to ensure unauthorized people do not broadcast emergency messages over the system. The emergency message may include a variety of information, including the nature of the emergency, the geographic area affected by the emergency, any timeframe for the emergency, recommended action for the user, or other appropriate information. The emergency message may be received by a server for the wireless communication system 100.

Proceeding to block 315, the wireless communication system 100 determines the geographic region targeted by the emergency message. The emergency message may be of a specific format wherein the targeted geographic region is encoded in the message. The targeted geographic region may also be supplied by the message originator in a separate communication. The wireless communication system 100 may even allow human intervention to determine the targeted region.

Proceeding to block 320, the wireless communication system 100 may enter an emergency mode. The emergency mode may be used to suspend the normal operations of the wireless communication system 100 and suspend or clear the message queue to allow for immediate transmission of the emergency message. The emergency mode may be enabled for a specific period of time during which the emergency message is repeatedly transmitted or may be enable for only a single transmission of the emergency message. The emergency mode may be as simple as ensuring the emergency message is transmitted with high priority.

Proceeding to block 325, the process 300 transmits the emergency message to all mobile stations 106 within the specified geographic region. A base station 104 which serves at least a portion of the specified geographical region may broadcast the emergency message to all mobile stations 106 currently communicating with the base station 104, even if some of these mobile stations 106 are not currently in the specified geographical region. Further, the wireless communication system 100 may periodically retransmit the emergency message during the period of time the message remains valid. The retransmission may serve as a reminder to the mobile stations 106 that received the original transmission, and may also reach other mobile stations 106 that have entered the specified geographical region since the original emergency message was transmitted. The emergency message may be broadcast to the mobile stations using the SMS over the WAP. The process 300 then terminates in END block 330.

FIG. 4 is a flowchart showing the process 400 used by the mobile station 106 upon receipt of the emergency message. The process 300 begins in a START block 405. Proceeding to block 410, the mobile station 106 receives an emergency message from the base station 104. The emergency message may be transmitted to the mobile station 106 in any manner, such as with the SMS system using the WAP protocol. The mobile station 106 receives the emergency message and the processor 205 decodes the message to determine the nature and extent of the emergency. The emergency message may be in a predetermined format to aid in the decoding process.

Proceeding to block 415, the mobile station 106 alerts the user that an emergency message has been received. The mobile station 106 may alert the user in a variety of manners, including and audio alert such as ringing, a visual alert such as flashing lights, or any other alerts. The mobile station 106 may also be set to override any user notification settings to ensure proper alert of an emergency message. For example, if the user has disabled the audio ringing of the mobile station 106, the emergency message may override that setting and ring the mobile station 106.

Proceeding to block 420, the mobile station 106 displays the emergency message to the user 420. The message may be displayed as text on a screen, or may be broadcast as a voice message. Any technique may be used to ensure the user receives the message. After communicating the message to the user, the process 400 terminates in END block 425.

Numerous variations and modifications of the invention will become readily apparent to those skilled in the art. Accordingly, the invention may be embodied in other specific forms without departing from its spirit or essential characteristics.

What is claimed is:

1. A method of distributing an emergency message comprising:
determining a geographic area affected by the emergency message;
selecting one or more mobile stations within the geographic area that may be potentially affected by the emergency message; and
transmitting the emergency message to the potentially affected mobile stations within the geographic area.

2. The method of claim 1, further comprising transferring the emergency message to one or more base stations which service the affected geographic area.

3. The method of claim 2, further comprising entering the emergency mode for each of the base stations receiving the emergency message.

4. The method of claim 3, further comprising transmitting the emergency message from the base stations in the emergency mode to the mobile stations.

5. The method of claim 1, further comprising alerting the user when the mobile station receives an emergency message.

6. The method of claim 1, further comprising transmitting the emergency message using the short messaging service (SMS).

7. The method of claim 6, further comprising transmitting the SMS using the wireless application protocol.

8. A wireless communication system comprising:
a server which communicates with a warning service, the server receiving an emergency message affecting a specific geographic region from the warning service;
a plurality of base stations which interface with the server, the server transferring the emergency message to any of the plurality of base stations which service the affected geographic region; and
at least one mobile station which communicates with one or more of the plurality of base stations;
wherein the position of the at least one mobile station is determined and compared to the affected geographic region, the emergency message being transmitted from one of the plurality of base stations to the at least one mobile station if the position is within the affected geographic region.

9. The wireless communication system of claim 8, wherein the mobile station alerts the user upon receipt of the emergency message.

10. The wireless communication system of claim 8, wherein the base station transmits the emergency message using the short messaging service.

11. The wireless communication system of claim 8, wherein the base station transmits the emergency message using a high priority.

12. The wireless communication system of claim 8, wherein the server decodes the emergency message.
